(19) United States
(12) Patent Application Publication
(10) Pub. No.: US 2025/0278956 A1
(43) Pub. Date: Sep. 4, 2025

(54) METHOD FOR RECOGNIZING AMMONIA NITROGEN STRESS BEHAVIOR OF RED-SPOTTED GROUPER BASED ON EMBEDDED DEVICE

(71) Applicant: Zhejiang University, Hangzhou City (CN)

(72) Inventors: Pengcheng NIE, Hangzhou City (CN); Cheng QIAN, Hangzhou City (CN); Xuehan LI, Hangzhou City (CN)

(21) Appl. No.: 19/051,386

(22) Filed: Feb. 12, 2025

(30) Foreign Application Priority Data
Feb. 29, 2024 (CN) 202410225812.X

(51) Int. Cl. G06V 40/20; A01K 29/00; A01K 61/00; G06V 10/764; G06V 10/77; G06V 10/774; G06V 10/776; G06V 10/82; G06V 20/40; G06V 40/10

(52) U.S. Cl. CPC G06V 40/20; A01K 29/005; A01K 61/00; G06V 10/764; G06V 10/7715; G06V 10/774; G06V 10/776; G06V 10/82; G06V 20/41; G06V 40/10

(57) ABSTRACT

Provided is a method for recognizing ammonia nitrogen stress behavior of red-spotted grouper based on an embedded device. The method includes: collecting behavior videos of red-spotted grouper during an aquaculture process, extracting video frames, annotating the video frames, and dividing the annotated video frames into a training set and a validation set; building a target detection model YOLOv5_GA, an improved target tracking model LD_Ocsort, and an ammonia nitrogen stress behavior classification model, inputting the training set and the validation set into the models for training and optimization, to obtained trained models; deploying the trained models to an embedded device, collecting video frames in real time, and inputting the collected video frames into the models for processing, to output recognition results of ammonia nitrogen stress behavior of the red-spotted grouper.

### CROSS REFERENCE TO RELATED APPLICATION

This patent application claims the benefit and priority of Chinese Patent Application No. 202410225812.X, filed with the China National Intellectual Property Administration on Feb. 29, 2024, the disclosure of which is incorporated by reference herein in its entirety as part of the present application.

### TECHNICAL FIELD

The present disclosure relates to a method for recognizing ammonia nitrogen stress behavior of grouper, and in particular, to a method for recognizing ammonia nitrogen stress behavior of red-spotted grouper based on an embedded device.

### BACKGROUND

Currently, there are mainly two methods for recognizing ammonia nitrogen stress behavior of red-spotted grouper. One is manual inspection, where aquaculture personnel assess the behavior of fish visually or manually extract water samples from aquaculture environments and analyze the ammonia nitrogen concentration using professional equipment. This method requires aquaculture personnel to have rich experience and imposes high demands on the real-time performance of inspections. The other method involves building an aquaculture water quality perception system based on ammonia nitrogen sensors, constructing an Internet of Things network using sensors, monitoring changes in ammonia nitrogen concentration in aquaculture water and setting thresholds, and triggering alarms when the ammonia nitrogen concentration in the aquaculture water exceeds the threshold. While this method is accurate and requires less manpower, limitations such as the high risk of corrosion and damage to sensors in seawater, as well as the high cost associated with the widespread use of high-precision ammonia nitrogen sensors, restrict the application of this method. Most high-precision ammonia nitrogen sensors currently rely on imports and have a short lifespan in seawater. As a result, the ammonia nitrogen sensor-based methods have high overall implementation cost and difficult to scale up.

### SUMMARY

To address the issues in the background technology, the present disclosure provides a method for recognizing ammonia nitrogen stress behavior of red-spotted grouper based on an embedded device. The method involves constructing a multi-target tracking model for red-spotted grouper that can run directly on an embedded device with limited computing power.

The present disclosure adopts the following technical solutions:

The method for recognizing ammonia nitrogen stress behavior of red-spotted grouper based on an embedded device of the present disclosure includes:
1) collecting behavior videos of red-spotted grouper during an aquaculture process, extracting a plurality of video frames, annotating the video frames, and dividing the annotated video frames into a training set and a validation set according to a preset ratio;
2) building a target detection model YOLOv5_GA, an improved target tracking model LD_Ocsort, and an ammonia nitrogen stress behavior classification model; inputting the training set and the validation set into the target detection model YOLOv5_GA for training and optimization; inputting detection results output by the target detection model YOLOv5_GA during training and optimization into the improved target tracking model LD_Ocsort for training and optimization; inputting a total number of body imbalances in the red-spotted grouper output by the target detection model YOLOv5_GA during training and optimization and displacement features of the red-spotted grouper output by the improved target tracking model LD_Ocsort during training and optimization into the ammonia nitrogen stress behavior classification model for training and optimization; stopping training when total loss of each model converges, thereby obtaining a trained target detection model YOLOv5_GA, a trained improved target tracking model LD_Ocsort, and a trained ammonia nitrogen stress behavior classification model; and
3) deploying the trained target detection model YOLOv5_GA, the trained improved target tracking model LD_Ocsort, and the trained ammonia nitrogen stress behavior classification model onto an embedded device at a red-spotted grouper aquaculture site to achieve lightweight, precise, and all-weather automatic assessment of ammonia nitrogen stress behavior of the red-spotted grouper; collecting video frames during the aquaculture process of the red-spotted grouper using the embedded device and inputting the collected video frames into the trained target detection model YOLOv5_GA for processing, to output detection results and a total number of body imbalances of the red-spotted grouper; inputting the detection results of the red-spotted grouper into the trained improved target tracking model LD_Ocsort for processing, to output displacement features of the red-spotted grouper; and inputting the total number of body imbalances and the displacement features of the red-spotted grouper as a representation of ammonia nitrogen stress behavior of the red-spotted grouper into the trained ammonia nitrogen stress behavior classification model for processing, to output recognition results of the ammonia nitrogen stress behavior of the red-spotted grouper, thereby achieving recognition of the ammonia nitrogen stress behavior of the red-spotted grouper.

In step 1), the behavior videos of the red-spotted grouper during the aquaculture process include a video of behavior in a normal water quality environment and a video of behavior in an ammonia nitrogen stress environment. After the video frames are extracted from the behavior videos, a position of each red-spotted grouper in the video frame is labeled with a rectangular box for each video frame; a behavior category of each red-spotted grouper in video frames from the normal water quality environment is labeled as a non-imbalance state, while a behavior category of each red-spotted grouper in video frames from the ammonia nitrogen stress environment is labeled as an imbalance state.

In step 2), the target detection model YOLOv5_GA includes an improved backbone network Ghostbackone, an improved asymptotic feature pyramid network AFPNeck, and a detection head section that are connected in sequence. The improved backbone network Ghostbackone includes a convolution module CBS, four feature extraction Ghost module groups, and a Spatial Pyramid Pooling-Fast (SPPF) module. The improved asymptotic feature pyramid network AFPNeck includes three feature extraction GhostV2 operators, two Adaptively Spatial Feature Fusion_2 (ASFF_2) modules, two feature extraction G3GhostV2 modules, and three Adaptively Spatial Feature Fusion_3 (ASFF_3) modules. Outputs of the second feature extraction Ghost module group, the third feature extraction Ghost module group, and the SPPF module are input into the three feature extraction GhostV2 operators, respectively. An output of the first feature extraction GhostV2 operator is input into the two ASFF_2 modules, and an output of the second feature extraction GhostV2 operator is also input into the two ASFF_2 modules. Outputs of the two ASFF_2 modules are input into the two feature extraction G3GhostV2 modules. An output of the first feature extraction G3GhostV2 module is input into the three ASFF_3 modules, an output of the second feature extraction G3GhostV2 module is input into the three ASFF_3 modules, and an output of the third feature extraction GhostV2 operator is also input into the three ASFF_3 modules. The detection head section includes three convolution layers, where outputs of the three ASFF_3 modules are input into the three convolution layers for processing, respectively, and then are combined to produce an output of the target detection model YOLOv5_GA.

The convolution module CBS (Conv2dBNSiLU) includes a convolution layer Conv2d, a batch normalization layer BN, and an activation function SiLU (short for Sigmoid Linear Unit) connected in sequence.

The target detection model YOLOv5_GA introduces the GhostV2 operator based on the YOLOv5 model and proposes a new C3Ghost feature extraction module to reduce parameters and computational load in the detection model. A progressive feature fusion method is built to achieve multi-scale fusion and enhance the feature fusion effect.

The feature extraction Ghost module group includes a feature extraction GhostV2 operator and a feature extraction G3GhostV2 module that are connected in sequence.

The feature extraction G3GhostV2 module includes three convolution modules CBS, a backbone network GhostV2backone, and a concatenation function Concat. An input to the feature extraction G3GhostV2 module is fed into the first and second convolution modules CBS. An output from the first convolution module CBS is input to the backbone network GhostV2backone for processing, and outputs from the second convolution modules CBS and the backbone network GhostV2backone are input into the concatenation function Concat. An output from the concatenation function Concat is input to the third convolution module CBS for processing, resulting in an output of the feature extraction G3GhostV2 module.

In step 2), the improved target tracking model LD_Ocsort is specifically implemented as follows: adding a fish re-identification (FishReID) network before an Observation-Centric Momentum (OCM) matching of an original target tracking model LD_Ocsort to extract appearance features from an input detection box, thereby constructing the improved target tracking model LD_Ocsort. The FishReID network includes a first 3×3 convolution layer Con2d, a first backbone network Ghostbackone1, a second backbone network Ghostbackone2, three attention backbone groups, a second 1×1 convolution layer Con2d, an 8×8 average pooling layer AvgPool, and a third 1×1 convolution layer Con2d that are connected in sequence. The attention backbone group includes an attention mechanism CBAM (short for Convolutional Block Attention Module), a first backbone network Ghostbackone1, and a second backbone network Ghostbackone2 that are connected in sequence.

In step 2), the ammonia nitrogen stress behavior classification model is specifically a Support Vector Machine (SVM) classification model.

Based on ammonia nitrogen stress experiments, features that can significantly characterize the ammonia nitrogen stress behavior of the red-spotted grouper are proposed. These features, combined with the proposed target detection model YOLOv5_GA and improved target tracking model LD_Ocsort, are used to extract the displacement features of the red-spotted grouper and the total number of body imbalances in the red-spotted grouper, which are then utilized to construct the SVM classification model.

The present disclosure first establishes a lightweight target detection model YOLOv5_GA for red-spotted grouper and optimizes the model through training, to achieve position detection of red-spotted grouper in video frames while also detecting body imbalances in the red-spotted grouper. Secondly, a lightweight target tracking model LD_Ocsort for red-spotted grouper is constructed and optimized through training to complete trajectory tracking of the red-spotted grouper in the video frames. Then, by combining the YOLOv5_GA detection model with the LD_Ocsort tracking model, displacement features and the total number of body imbalances in the red-spotted grouper are extracted to characterize behavior of the red-spotted grouper. Subsequently, an ammonia nitrogen stress behavior classification model for red-spotted grouper is constructed based on an SVM classification model, and finally, the method for recognizing ammonia nitrogen stress behavior is deployed to an embedded device.

The present disclosure has following beneficial effects:

Compared to traditional recognition methods, which face issues such as high labor intensity, slow detection speed, and high deployment costs, by directly characterizing ammonia nitrogen stress behavior of red-spotted grouper, the present disclosure creatively proposes a lightweight method for recognizing ammonia nitrogen stress behavior based on target detection extraction and trajectory tracking. This method can be easily deployed on an embedded device and installed at a red-spotted grouper intensive farming site, requiring minimal labor and cost while meeting the demands for all-weather detection of ammonia nitrogen stress behavior in red-spotted grouper, thereby reducing the risk of ammonia nitrogen stress during aquaculture.

### BRIEF DESCRIPTION OF THE DRAWINGS

FIG. 1 is an overall flowchart according to the present disclosure;

FIG. 2 is a schematic diagram of a target detection model YOLOv5_GA constructed according to the present disclosure;

FIG. 3 is a schematic diagram of a FishReID appearance feature extraction network constructed according to the present disclosure;

FIG. 4 is a schematic diagram of a target tracking model LD_Ocsort constructed according to the present disclosure;

FIG. 5 illustrates a recognition effect for ammonia nitrogen stress behavior of red-spotted grouper achieved by the method for recognizing ammonia nitrogen stress behavior proposed in the present disclosure;

FIG. 6 is a schematic diagram of an image acquisition and processing approach when the method of the present disclosure is deployed at a red-spotted grouper farming site; and

FIGS. 7A-7D is a schematic diagram of detection and tracking results for red-spotted grouper using the method of the present disclosure, where FIG. 7A shows a detection result of red-spotted grouper in a normal water quality environment, FIG. 7B shows a detection result of red-spotted grouper in an ammonia nitrogen stress environment, FIG. 7C shows a tracking result of red-spotted grouper in a normal water quality environment, and FIG. 7D shows a tracking result of red-spotted grouper in an ammonia nitrogen stress environment.

### DETAILED DESCRIPTION OF THE EMBODIMENTS

The present disclosure is described in further detail below with reference to the accompanying drawings and specific embodiments.

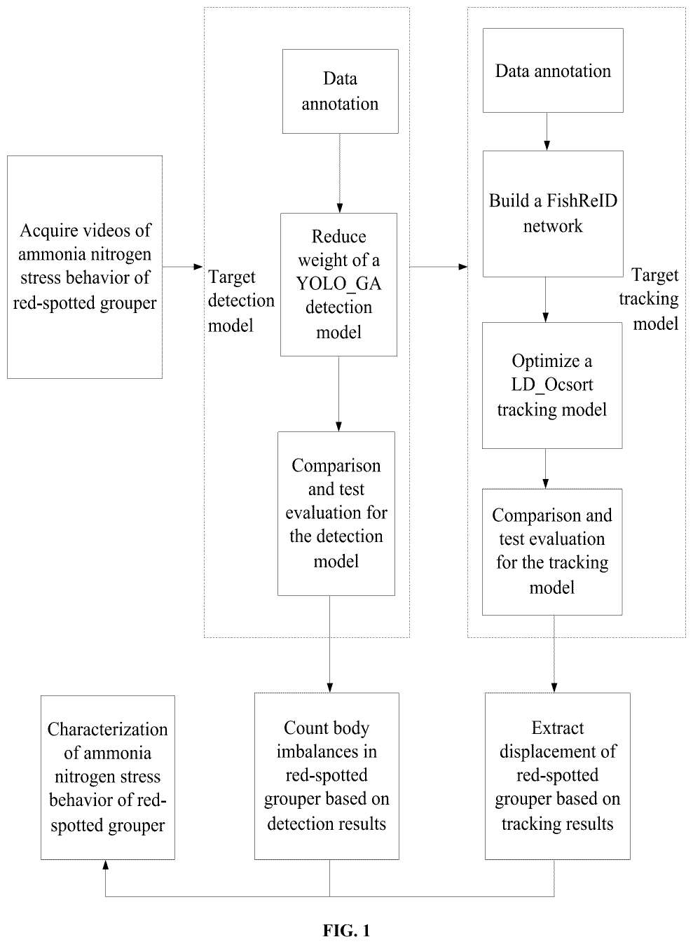

As shown in FIG. 1, a method for recognizing ammonia nitrogen stress behavior in red-spotted grouper based on an embedded device according to the present disclosure includes the following steps:
1) Collect behavior videos of red-spotted grouper during an aquaculture process, extract a plurality of video frames, annotate the video frames, and divide the annotated video frames into a training set and a validation set according to a preset ratio. During implementation, the annotated video frames are divided into a training set, a validation set, and a test set based on a ratio of 6:2:2.

In step 1), the behavior videos of the red-spotted grouper during the aquaculture process include a video of behavior in a normal water quality environment and a video of behavior in an ammonia nitrogen stress environment. After the video frames are extracted from the behavior videos, a position of each red-spotted grouper in the video frame is labeled with a rectangular box for each video frame; a behavior category of each red-spotted grouper in video frames from the normal water quality environment is labeled as a non-imbalance state, while a behavior category of each red-spotted grouper in video frames from the ammonia nitrogen stress environment is labeled as an imbalance state.
2) Build a target detection model YOLOv5_GA, an improved target tracking model LD_Ocsort, and an ammonia nitrogen stress behavior classification model; input the training set and the validation set into the target detection model YOLOv5_GA for training and optimization; input detection results output by the target detection model YOLOv5_GA during training and optimization into the improved target tracking model LD_Ocsort for training and optimization; inputting a total number of body imbalances in the red-spotted grouper output by the target detection model YOLOv5_GA during training and optimization and displacement features of the red-spotted grouper output by the improved target tracking model LD_Ocsort during training and optimization into the ammonia nitrogen stress behavior classification model for training and optimization; stopping training when total loss of each model converges, thereby obtaining a trained target detection model YOLOv5_GA, a trained improved target tracking model LD_Ocsort, and a trained ammonia nitrogen stress behavior classification model.

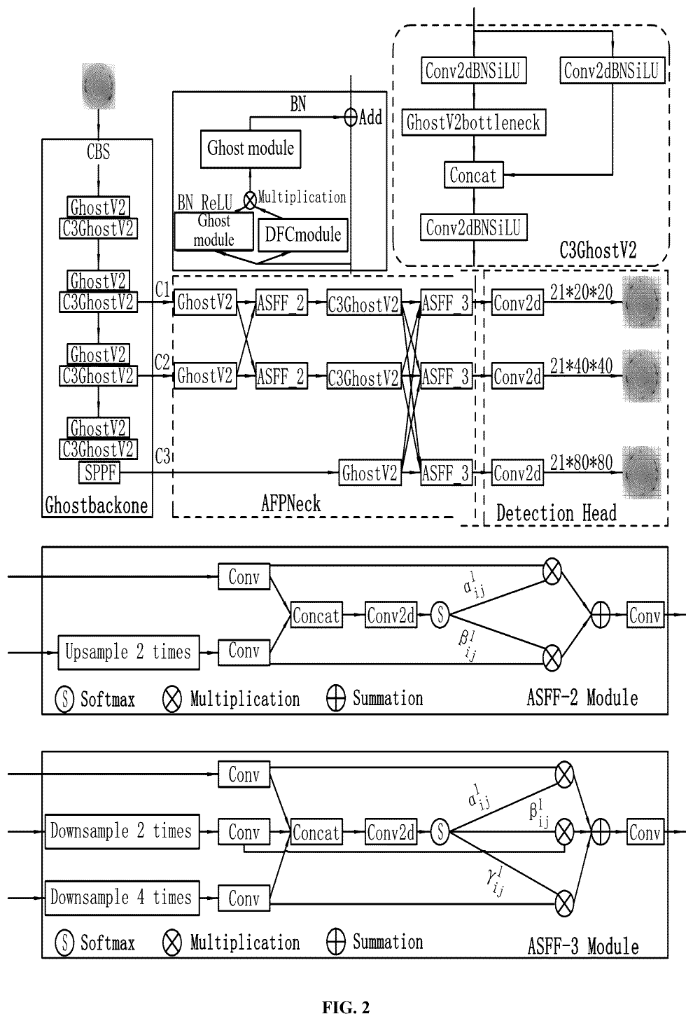

As shown in FIG. 2, in step 2), the target detection model YOLOv5_GA includes an improved backbone network Ghostbackone, an improved asymptotic feature pyramid network AFPNeck, and a detection head section that are connected in sequence. The improved backbone network Ghostbackone includes a convolution module CBS, four feature extraction Ghost module groups, and a Spatial Pyramid Pooling-Fast (SPPF) module that are connected in sequence. The improved asymptotic feature pyramid network AFPNeck includes three feature extraction GhostV2 operators, two Adaptively Spatial Feature Fusion_2 (ASFF_2) modules, two feature extraction G3GhostV2 modules, and three Adaptively Spatial Feature Fusion_3 (ASFF_3) modules. Outputs of the second feature extraction Ghost module group, the third feature extraction Ghost module group, and the SPPF module are input into the three feature extraction GhostV2 operators, respectively. An output of the first feature extraction GhostV2 operator is input into the two ASFF_2 modules, and an output of the second feature extraction GhostV2 operator is also input into the two ASFF_2 modules. Outputs of the two ASFF_2 modules are input into the two feature extraction G3GhostV2 modules. An output of the first feature extraction G3GhostV2 module is input into the three ASFF_3 modules, an output of the second feature extraction G3GhostV2 module is input into the three ASFF_3 modules, and an output of the third feature extraction GhostV2 operator is also input into the three ASFF_3 modules. The detection head section includes three convolution layers, where outputs of the three ASFF_3 modules are input into the three convolution layers for processing, respectively, and then are combined to produce an output of the target detection model YOLOv5_GA.

The convolution module CBS includes a convolution layer Conv2d, a batch normalization layer BN, and an activation function SiLU connected in sequence.

The target detection model YOLOv5_GA introduces the GhostV2 operator based on the YOLOv5 model and proposes a new C3Ghost feature extraction module to reduce parameters and computational load in the detection model. A progressive feature fusion method is built to achieve multi-scale fusion and enhance the feature fusion effect.

In the specific implementation, the improved YOLOv5_GA. 8000 images are divided into a training set, a validation set, and a test set based on a ratio of 6:2:2, the momentum of the training phase is set to 0.937, the initial learning rate is set to 0.01, the batch size is set to 16, the input image size is 640×640, and the training is performed using a stochastic gradient descent SGD optimizer. Training is stopped upon detection that the total loss of the model converges.

The feature extraction Ghost module group includes a feature extraction GhostV2 operator and a feature extraction G3GhostV2 module that are connected in sequence. The feature extraction G3GhostV2 module includes three convolution modules CBS, a backbone network GhostV2backone, and a concatenation function Concat. An input to the feature extraction G3GhostV2 module is fed into the first and second convolution modules CBS. An output from the first convolution module CBS is input to the backbone network GhostV2backone for processing, and outputs from the second convolution modules CBS and the backbone network GhostV2backone are input into the concatenation function Concat. An output from the concatenation function Concat is input to the third convolution module CBS for processing, resulting in an output of the feature extraction G3GhostV2 module.

In step 2), the improved target tracking model LD_Ocsort is specifically implemented as follows: adding a fish re-identification (FishReID) network before an OCM matching of an original target tracking model LD_Ocsort to extract appearance features from an input detection box, thereby constructing the improved target tracking model LD_Ocsort.

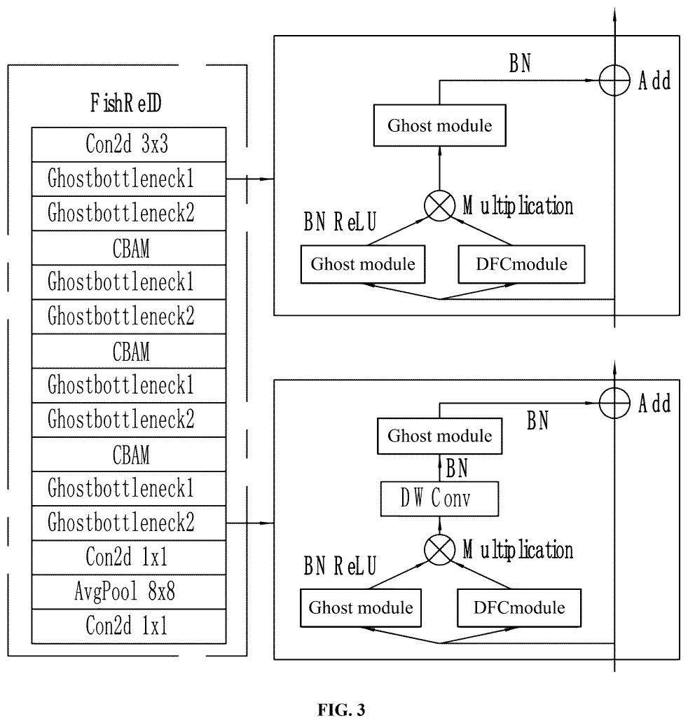

As shown in FIG. 3, the FishReID network includes a first 3×3 convolution layer Con2d, a first backbone network Ghostbackone1, a second backbone network Ghostbackone2, three attention backbone groups, a second 1×1 convolution layer Con2d, an 8×8 average pooling layer AvgPool, and a third 1×1 convolution layer Con2d that are connected in sequence. The attention backbone group includes an attention mechanism CBAM, a first backbone network Ghostbackone1, and a second backbone network Ghostbackone2 that are connected in sequence.

In step 2), the ammonia nitrogen stress behavior classification model is specifically a Support Vector Machine (SVM) classification model. Based on ammonia nitrogen stress experiments, features that can significantly characterize the ammonia nitrogen stress behavior of the red-spotted grouper are proposed. These features, combined with the proposed target detection model YOLOv5_GA and improved target tracking model LD_Ocsort, are used to extract the displacement features of the red-spotted grouper and the total number of body imbalances in the red-spotted grouper, which are then utilized to construct the SVM classification model.
3) Deploy the trained target detection model YOLOv5_GA, the trained improved target tracking model LD_Ocsort, and the trained ammonia nitrogen stress behavior classification model onto an embedded device at a red-spotted grouper aquaculture site to achieve lightweight, precise, and all-weather automatic assessment of ammonia nitrogen stress behavior of the red-spotted grouper; collect video frames during the aquaculture process of the red-spotted grouper using the embedded device and input the collected video frames into the trained target detection model YOLOv5_GA for processing, to output detection results and a total number of body imbalances of the red-spotted grouper; input the detection results of the red-spotted grouper into the trained improved target tracking model LD_Ocsort for processing, to output displacement features of the red-spotted grouper; and input the total number of body imbalances and the displacement features of the red-spotted grouper as a representation of ammonia nitrogen stress behavior of the red-spotted grouper into the trained ammonia nitrogen stress behavior classification model for processing, to output recognition results of the ammonia nitrogen stress behavior of the red-spotted grouper, thereby achieving recognition of the ammonia nitrogen stress behavior of the red-spotted grouper.

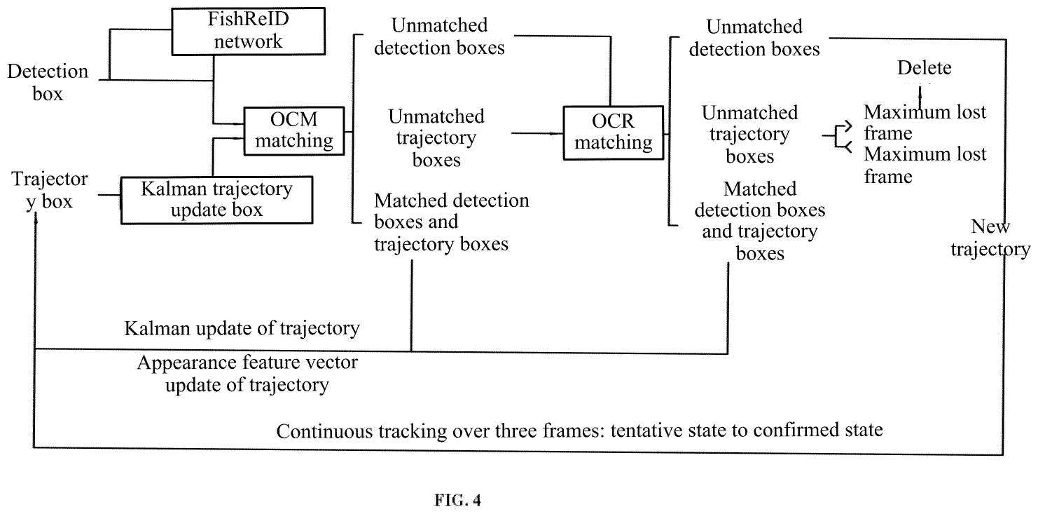

As shown in FIG. 4, the tracking process of LD_Ocsort is as follows: First, the FishReID network of the target detection model detects detection boxes of targets in the current frame. At the same time, target trajectory boxes that have been tracked continuously for three frames and transitioned from tentative states to confirmed states are predicted using a Kalman filter. Next, the OCM associates target prediction boxes from the previous frame with the detection boxes from the current frame, integrating momentum feature information, appearance similarity information, and intersection-over-union (IoU) information of the prediction boxes and the detection boxes into a matching cost matrix. A Hungarian algorithm is then used to assign IDs and track the targets. Following that, unmatched prediction boxes and unmatched detection boxes are input into the OCR. After obtaining an appearance similarity cost matrix of the unmatched prediction boxes and unmatched detection boxes, the OCR performs matching using the Hungarian algorithm.

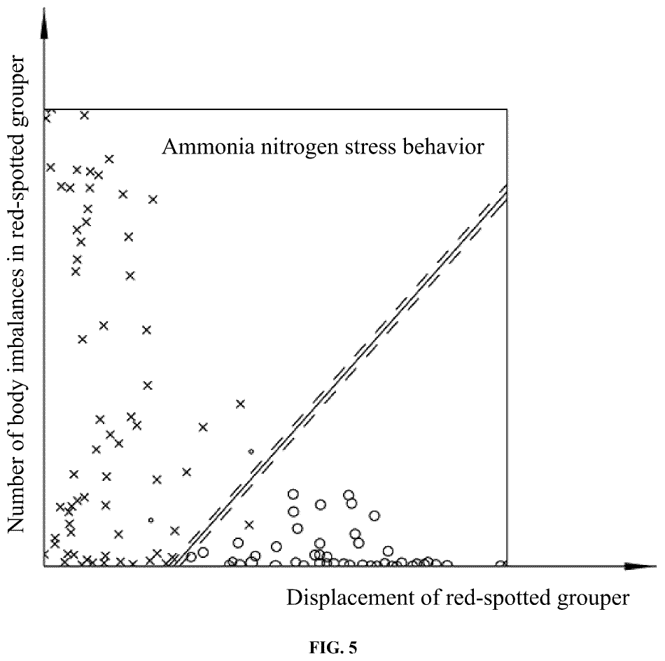

FIG. 5 illustrates a recognition effect for ammonia nitrogen stress behavior of red-spotted grouper achieved by the method for recognizing ammonia nitrogen stress behavior proposed in the present disclosure. First, videos collected on site are divided into a training set and a validation set based on a ratio of 7:3. Then, the two features, including the displacement and the number of body imbalances of red-spotted grouper, extracted using a stress behavior characterization method are input into the SVM classification model for training. Ultimate classification results for the training set are as shown in FIG. 5, with an accuracy rate of 92.2% on the validation set, enabling a relatively accurate detection of whether the population of red-spotted grouper is in an ammonia nitrogen stress environment.

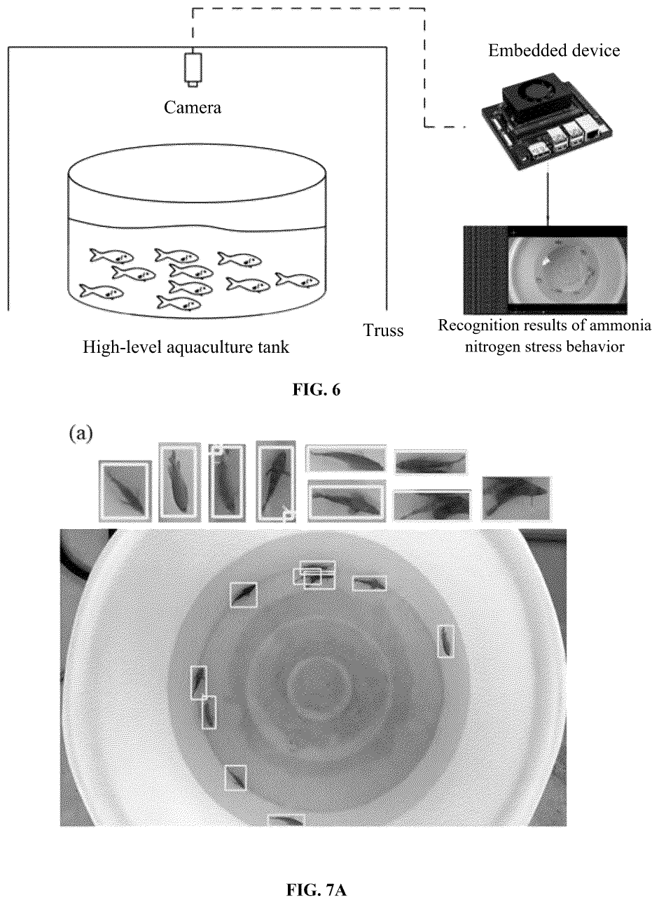

FIG. 6 illustrates an image acquisition and processing approach of an embedded device according to the present disclosure. The method for recognizing ammonia nitrogen stress behavior is deployed on an Orin nano embedded device. A camera is installed at a fixed position above a high-level aquaculture tank where red-spotted grouper are raised, mounted on a truss, and is oriented downward to capture an aquaculture video of the red-spotted grouper in the high-level aquaculture tank. The embedded device processes the red-spotted grouper video captured by the camera and outputs recognition results of the ammonia nitrogen stress behavior.

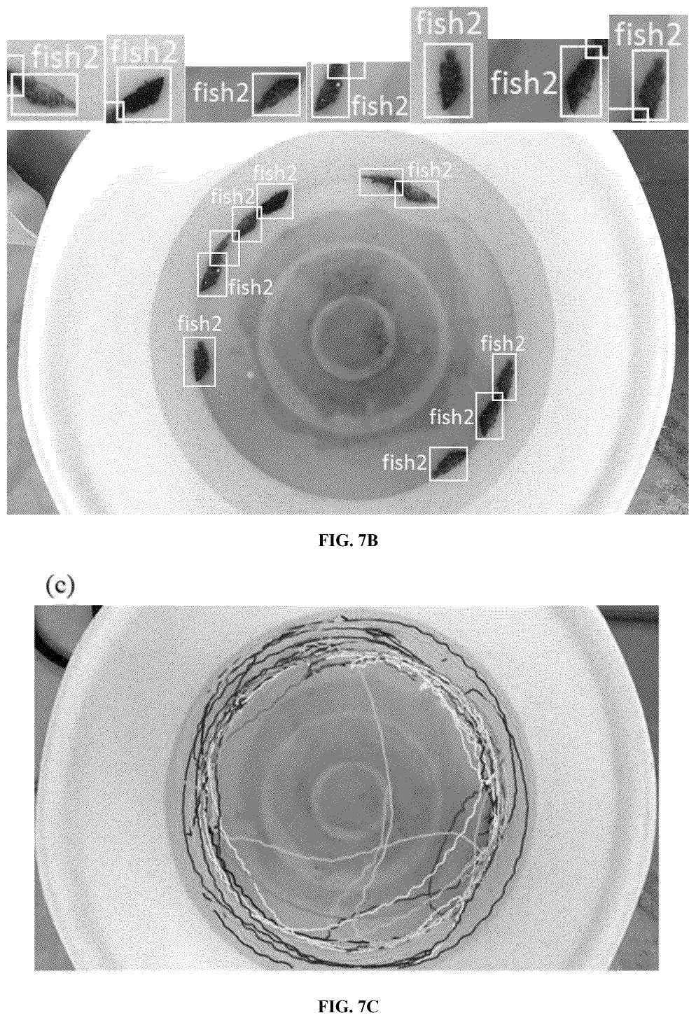

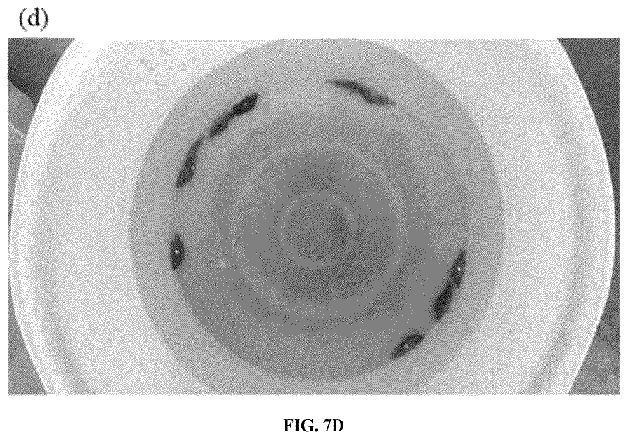

FIG. 7A, FIG. 7B, FIG. 7C, and FIG. 7D illustrate detection and tracking results of red-spotted grouper under a normal water quality environment and an ammonia nitrogen stress environment using the method of the present disclosure. Comparison results between the present disclosure and other models are shown in Table 1 and Table 2 below:

TABLE 1
Comprehensive comparison results of different detection models

| Detection model | mAP@0.5/% | mAP@0.5:0.95/% | Memory/MB |
|---|---|---|---|
| YOLOv5_GA | 96.2 | 65.9 | 8.04 |
| YOLOv8s | 96.5 | 71.4 | 21.4 |
| Faster R-CNN | 95.8 | 70.9 | 321 |
| SSD | 91.6 | 51.3 | 188 |

TABLE 2
Comprehensive comparison results of different tracking model

| Detection | | | | |
|---|---|---|---|---|
| model | Tracking model | MOTA/% | ID F1/% | Memory/MB |
| YOLOv5_{—} | DeepSort | 89.2 | 46.5 | 8.04 + 43.2 |
| GA | OC-SORT | 93.1 | 67.1 | 8.04+/ |
| | LD_Ocsort | 94.7 | 69.3 | 8.04 + 5.27 |
| YOLOv5s | DeepSort | 90.2 | 49.9 | 13.7 + 43.2 |
| | OC-SORT | 91.5 | 62.6 | 13.7+/ |
| | LD_Ocsort | 91.6 | 69.0 | 13.7 + 5.27 |

From the above tables, it can be seen that the method of the present disclosure can achieve lightweight and accurate detection of ammonia nitrogen stress behavior in red-spotted grouper.

What is claimed is:

1. A method for recognizing ammonia nitrogen stress behavior of red-spotted grouper based on an embedded device, comprising:
1) collecting behavior videos of red-spotted grouper during an aquaculture process, extracting a plurality of video frames, annotating the video frames, and dividing the annotated video frames into a training set and a validation set according to a preset ratio;
2) building a target detection model YOLOv5_GA, an improved target tracking model LD_Ocsort, and an ammonia nitrogen stress behavior classification model; inputting the training set and the validation set into the target detection model YOLOv5_GA for training and optimization; inputting detection results output by the target detection model YOLOv5_GA during training and optimization into the improved target tracking model LD_Ocsort for training and optimization; inputting a total number of body imbalances in the red-spotted grouper output by the target detection model YOLOv5_GA during training and optimization and displacement features of the red-spotted grouper output by the improved target tracking model LD_Ocsort during training and optimization into the ammonia nitrogen stress behavior classification model for training and optimization; stopping training when total loss of each model converges, thereby obtaining a trained target detection model YOLOv5_GA, a trained improved target tracking model LD_Ocsort, and a trained ammonia nitrogen stress behavior classification model; and
3) deploying the trained target detection model YOLOv5_GA, the trained improved target tracking model LD_Ocsort, and the trained ammonia nitrogen stress behavior classification model onto an embedded device at a red-spotted grouper aquaculture site; collecting video frames during the aquaculture process of the red-spotted grouper using the embedded device and inputting the collected video frames into the trained target detection model YOLOv5_GA for processing, to output detection results and a total number of body imbalances of the red-spotted grouper; inputting the detection results of the red-spotted grouper into the trained improved target tracking model LD_Ocsort for processing, to output displacement features of the red-spotted grouper; and inputting the total number of body imbalances and the displacement features of the red-spotted grouper as a representation of ammonia nitrogen stress behavior of the red-spotted grouper into the trained ammonia nitrogen stress behavior classification model for processing, to output recognition results of the ammonia nitrogen stress behavior of the red-spotted grouper, thereby achieving recognition of the ammonia nitrogen stress behavior of the red-spotted grouper.

2. The method for recognizing ammonia nitrogen stress behavior of red-spotted grouper based on an embedded device according to claim 1, wherein in step 1), the behavior videos of the red-spotted grouper during the aquaculture process comprise a video of behavior in a normal water quality environment and a video of behavior in an ammonia nitrogen stress environment; after the video frames are extracted from the behavior videos, a position of each red-spotted grouper in the video frame is labeled with a rectangular box for each video frame; a behavior category of each red-spotted grouper in video frames from the normal water quality environment is labeled as a non-imbalance state, while a behavior category of each red-spotted grouper in video frames from the ammonia nitrogen stress environment is labeled as an imbalance state.

3. The method for recognizing ammonia nitrogen stress behavior of red-spotted grouper based on an embedded device according to claim 1, wherein in step 2), the target detection model YOLOv5_GA comprises an improved backbone network Ghostbackone, an improved asymptotic feature pyramid network AFPNeck, and a detection head section that are connected in sequence; the improved backbone network Ghostbackone comprises a convolution module CBS, four feature extraction Ghost module groups, and a Spatial Pyramid Pooling-Fast (SPPF) module that are connected in sequence; the improved asymptotic feature pyramid network AFPNeck comprises three feature extraction GhostV2 operators, two Adaptively Spatial Feature Fusion_2 (ASFF_2) modules, two feature extraction G3GhostV2 modules, and three Adaptively Spatial Feature Fusion_3 (ASFF_3) modules; outputs of the second feature extraction Ghost module group, the third feature extraction Ghost module group, and the SPPF module are input into the three feature extraction GhostV2 operators, respectively; an output of the first feature extraction GhostV2 operator is input into the two ASFF_2 modules, and an output of the second feature extraction GhostV2 operator is also input into the two ASFF_2 modules; outputs of the two ASFF_2 modules are input into the two feature extraction G3GhostV2 modules; an output of the first feature extraction G3GhostV2 module is input into the three ASFF_3 modules, an output of the second feature extraction G3GhostV2 module is input into the three ASFF_3 modules, and an output of the third feature extraction GhostV2 operator is also input into the three ASFF_3 modules; the detection head section comprises three convolution layers, wherein outputs of the three ASFF_3 modules are input into the three convolution layers for processing, respectively, and then are combined to produce an output of the target detection model YOLOv5_GA.

4. The method for recognizing ammonia nitrogen stress behavior of red-spotted grouper based on an embedded device according to claim 3, wherein the feature extraction Ghost module group comprises a feature extraction GhostV2 operator and a feature extraction G3GhostV2 module that are connected in sequence.

5. The method for recognizing ammonia nitrogen stress behavior of red-spotted grouper based on an embedded device according to claim 3, wherein the feature extraction G3GhostV2 module comprises three convolution modules CBS, namely, a first convolution module CBS, a second convolution module CBS, and a third convolution module CBS, a backbone network GhostV2backone, and a concatenation function Concat; an input to the feature extraction G3GhostV2 module is fed into the first and second convolution modules CBS; an output from the first convolution module CBS is input to the backbone network GhostV2backone for processing, and outputs from the second convolution modules CBS and the backbone network GhostV2backone are input into the concatenation function Concat; an output from the concatenation function Concat is input to the third convolution module CBS for processing, resulting in an output of the feature extraction G3GhostV2 module.

6. The method for recognizing ammonia nitrogen stress behavior of red-spotted grouper based on an embedded device according to claim 1, wherein in step 2), the improved target tracking model LD_Ocsort is specifically implemented as follows: adding a fish re-identification (FishReID) network before an Observation-Centric Momentum (OCM) matching of an original target tracking model LD_Ocsort to extract appearance features from an input detection box, thereby constructing the improved target tracking model LD_Ocsort; the FishReID network comprises a first convolution layer Con2d, a first backbone network Ghostbackone1, a second backbone network Ghostbackone2, three attention backbone groups, a second convolution layer Con2d, an average pooling layer AvgPool, and a third convolution layer Con2d that are connected in sequence; the attention backbone group comprises an attention mechanism CBAM, a first backbone network Ghostbackone1, and a second backbone network Ghostbackone2 that are connected in sequence.

7. The method for recognizing ammonia nitrogen stress behavior of red-spotted grouper based on an embedded device according to claim 1, wherein in step 2), the ammonia nitrogen stress behavior classification model is specifically a Support Vector Machine (SVM) classification model.
